(19) United States
(12) Patent Application Publication
(10) Pub. No.: US 2009/0177629 A1
(43) Pub. Date: Jul. 9, 2009

(54) Users Profiling Method

(75) Inventor: Roberto Salemi, Milano (IT)

Correspondence Address: SHOEMAKER AND MATTARE, LTD, 10 POST OFFICE ROAD - SUITE 100, SILVER SPRING, MD, 20910, US

(73) Assignee: Blurum S.r.l., Milano (IT)

(21) Appl. No.: 12/297,955

(22) PCT Filed: Apr. 21, 2006
(86) PCT No.: PCT/IT2006/000272

§ 371 Date: Feb. 5, 2009

(51) Int. Cl. G06F 17/30; G06Q 30/00

(52) U.S. Cl. 707/3; 707/104.1; 705/14; 707/E17.044; 707/E17.014; 707/10; 707/E17.001

(57) ABSTRACT

A profiling method of a plurality of users (UT1-UTN) of goods is described, the method comprising:
prearranging, in a main database (DBP) associated with a management centre (100), a first plurality of distinctive attributes of each user and a second plurality of distinctive attributes of each good;
providing each user with a respective use information acquisition instrument;
acquiring, by means of said instrument and during a use of goods by users, respective use information (IU) representative of the occurred use;
storing, in the database (DBP), said respective use information (IU), associating it with the corresponding user and the corresponding good.

### FIELD OF THE INVENTION

The present invention refers to a profiling method of goods users. In particular, it refers to a profiling method which employs a telematic network.

### TECHNOLOGICAL BACKGROUND OF THE INVENTION

For the present invention, by “good” usable by a user it is intended both a product (for example, an optical multimedia support such as a CD, a DVD, a CD-ROM) and a service (for example, the service offered by an Internet search engine, the messenger service, responding to online surveys or listening to the radio via web).

The profiling and study of the behaviour of consumption goods users today have considerable importance for many applications, such as for example promotions and advertising, with the increasingly sought-after objective of attracting the attention of potential users.

The profile of the users is typically created beginning with great amounts of information, normally collected by carrying out market research and related to the behaviour of the users themselves with regard to commercial goods. The conventional methods of profiling users foresee a collection of such information conducted according to several different possible modes.

In a first case, questionnaires may be used, i.e. modules with multiple choice questions compiled by the users at the moment of their purchase of a product. In other cases, the charged personnel interviews the clients of a shopping centre with regard to the shopping carried out. Another example of information collection foresees that the questionnaires are sent by mail to the users, who compile them and send them to the sender. In addition, market research is often conducted by telephone, subjecting the user to a long series of questions on a specific subject. There are also several centres wherein the users may intentionally go to compile questionnaires on the most varied subjects in exchange for an economical compensation.

Finally, it is known that notwithstanding the rising diffusion of the computer in every sector of industry, commerce and among the population, computers have until now been predominantly used in the field of market research for the processing of the information collected for such purpose, for example for creating statistical models which permits obtaining increasingly reliable users profiling. Therefore, in the field of market research and in that of profiling, computer technology does not appear to have been fully exploited.

Moreover, there is the need for profiling methods which permit evaluating the effective behaviour of the users not only based on the purchases which they intend on carrying out or on the enjoyment for an already-purchased product, but also in relation to the actual use of products already in their possession, even those that they have possessed since long before the study.

### SUMMARY OF THE INVENTION

The object of the present invention is to propose a profiling method of goods users adapted to improve the modes and quality of the collection of information related to the user behaviour and which overcomes, for example, the above-indicated limitations of the conventional methodologies.

Such object is attained by a method of profiling a plurality of users of goods comprising:

prearranging, in a main database associated with a management centre, a first plurality of distinctive attributes of each user and a second plurality of distinctive attributes of each good;

providing each user with a respective use information acquisition instrument;

acquiring, by means of said instrument and during a use of goods by the users, respective use information (IU) representative of the occurred use;

storing, in the database, said respective use information (IU), associating it with the corresponding user and the corresponding good.

Moreover, a telematic network is also an object of the present invention for the profiling of a plurality of users of goods comprising:

a management centre of user profiling data;

an electronic computer associated with a user equipped with a respective use information acquisition instrument such to acquire, during a use of a good by the user, a respective use information, representative of the occurred use;

a main database associated with the management centre adapted to store the use information, associating it with the corresponding user and the corresponding good.

According to another aspect, the present invention regards a computer program loadable in a memory of an electronic computer associated with a user of goods, said program comprising codes capable of:

acquiring a first plurality of distinctive attributes of the user;

acquiring, during the use of a good by the user, a second plurality of distinctive attributes of the good;

acquiring, during said use of the good, use information representative of the occurred use;

generating associated information obtained by associating the use information with the first plurality of distinctive attributes and with the second plurality of distinctive attributes of the good.

### BRIEF DESCRIPTION OF THE FIGURES

The invention will be better understood by the following detailed description of one of its embodiments given as exemplifying and not in the least limiting, with reference to the set of drawings, wherein:

FIG. 1 shows a telematic network according to one example of the invention,

FIG. 2 schematically shows a computer associated with a user of the network of FIG. 1, and

FIG. 3 shows a flow diagram of a procedure of a profiling method according to one example of the invention.

### DESCRIPTION OF PREFERRED EMBODIMENTS

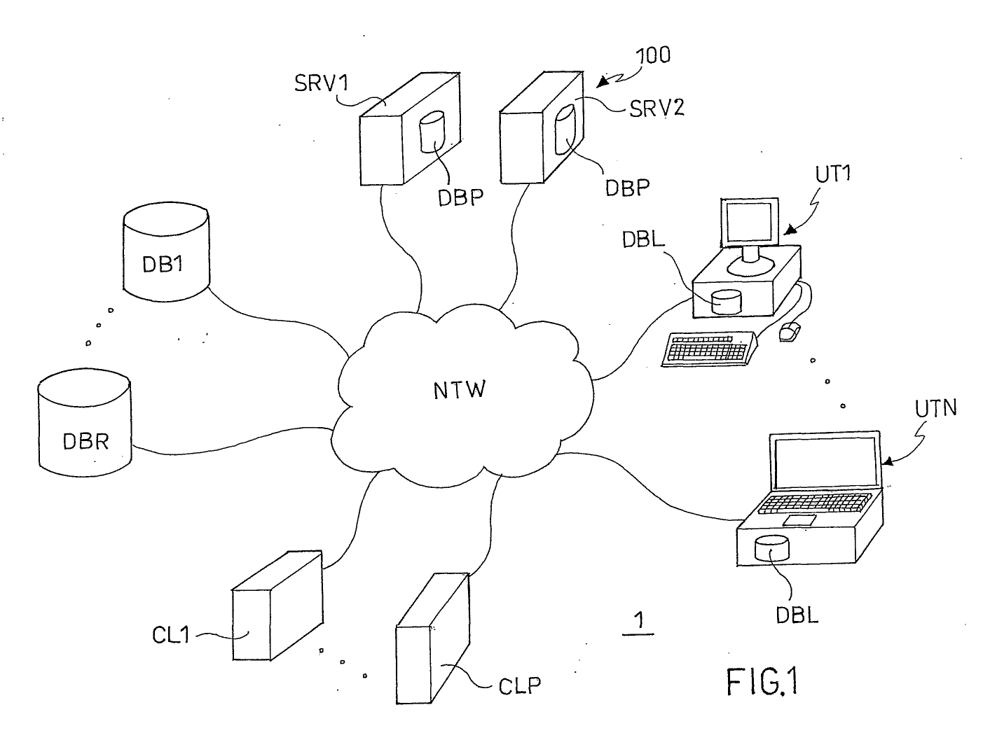

With reference to FIG. 1, a telematic network architecture, or in short a network, indicated generally with the reference number 1, comprises a first computer server SRV1 and a second computer server SRV2 included in a user profiling data management centre 100. The network 1 moreover includes a plurality of local electronic computers (or local computers) UT1-UTN, one or more of said local computers associable with a user belonging to a plurality of users UL-UK which may use goods. As already defined above, by ‘good’ it is intended both a product and a service. Examples of goods and services usable by users which may be profiled by means of the network of the invention will be provided below.

The network 1 is also advantageously provided with a plurality of remote databases DB1-DBR, each stored in a corresponding remote computer and associated with a specific category of goods usable by the users. A plurality of client computers CL1-CLP are included in the network 1, each of which associable with a firm or company requiring a service offered by the management centre 100.

The first SRV1 and second SRV2 computer server respectively comprise memory units wherein the users profiling data acquired by the management centre 100 is stored. Advantageously, to increase the performances of the network 1, there may be foreseen, in combination with the computer servers SRV1 and SRV2, an auxiliary computer server (not shown in FIG. 1), which preferably comprises several reduced size and reduced cost memory units, organised so to have a redundancy which cannot be attained with the single unit mentioned above, per se costly and of greater size, so to relieve the first and second computer server from a possible excessive activity. The memory units of the first SRV1 and second SRV1 computer server and the possible auxiliary computer represent an example of main database DBP associated with the management centre 100 and prearranged for storing profiling data comprising a first plurality of distinctive attributes AU of each user and a second plurality of distinctive attributes AA of each good. As will be clearer below, the attributes of the users are information/data related to the identity and/or other characteristics of the user and the attributes of the good are data/information related to the type and/or other characteristics (for example, of commercial type) which characterise the good.

The plurality of remote databases DB1-DBR comprises databases dedicated to the practically exhaustive cataloguing of items on the market, for example CDs or DVDs and so on. For example, a remote database, indicated with DB1, could be dedicated to audio CDs, cataloguing them based on conventional publishing data of a CD (composer, performer, title of the work, titles of the tracks).

Regarding the local computers UT1-UTN, these comprise both conventional fixed electronic computers (personal computer desktops) and conventional portable electronic computers (notebooks), or even fixed or mobile telephone terminals (such as cellular phones). The plurality of users U1-Uk may be equipped, whether at home or at work, with one or more electronic computers belonging to one or more of the above indicated types.

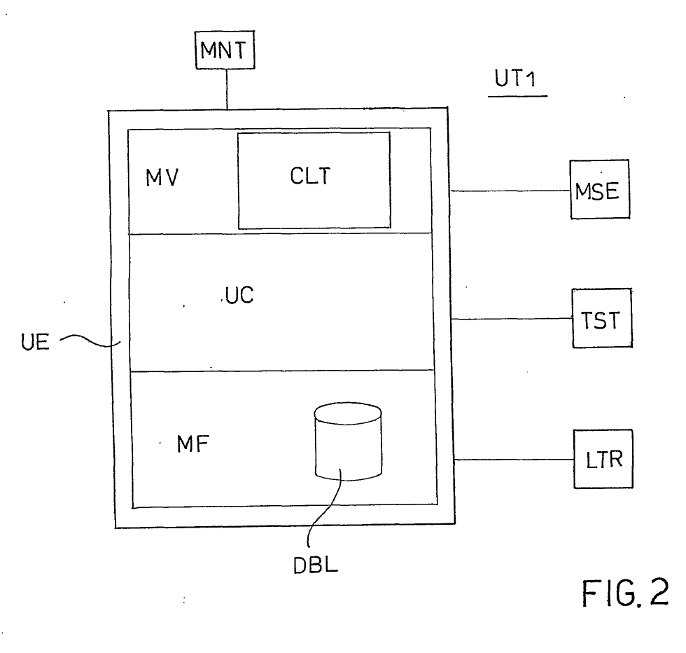

With reference to the diagram of FIG. 2, a local computer, generally indicated with the reference UT1, comprises a processing unit UE to which a monitor MNT, a keyboard TST and a mouse MSE are operatively connected. The processing unit UE preferably includes a command unit or microprocessor UC, a volatile memory (or RAM) MV adapted to load and execute the application programs, and a non-volatile memory ROM (hard disk) MNV wherein it is possible to store the processed data in local databases. The local computer UT1 is also equipped with conventional hardware (not shown in FIG. 2) and related software for accessing the network NTW and navigating the Internet, using email, messenger or chat services. The processing unit UE is moreover operatively connected to a reader LTR of optical multimedia supports (audio and video CDs and DVDS, CD-ROMs), usually assembled inside the processing unit UE itself, or, according to another conventional example, outside the processing unit UE itself and operatively connectable to it in a manner which is entirely analogous to that which occurs, for example, for the mouse MSE and the keyboard TST. It is known, advantageously, that the reader LTR of the described example recognises and plays without distinction audio-video CDs and DVDs and CD-ROMs, as is currently the trend in the market and the field technology development. Alternatively, it is foreseeable that a computer may also be provided with separate reading devices, for example with a first reader which only reads/writes audio CDs and CD-ROMs and a second reader which only reads/writes DVDs. The reader LTR, both internally and externally associable with the electronic computer of a user, represents an electronic device example by which the user himself can use a good. The recognition and playing of a good by means of the reader LTR is an example of that which generally can be defined an interaction between the good and the reader LTR associated with the user. For example, by playing it is intended listening to the CD or audio file or visualising a DVD or video file.

The plurality of client computers CL1-CLP permits respective firms or companies to access the profiling data acquired from the management centre 100 by means of a payment service. It is for this reason that said companies may be defined as clients. The operative modes of this service and the type of extractable data will be described below. Examples of companies of the type mentioned above are preferably record or film companies, editors of daily and periodic publications and other widespread publications with or without optical support provided, videogame distributors, or generally producers and distributors of entertainment goods and so on.

For the implementation of the users profiling method according to one embodiment of the invention, it is necessary that the local computer UT1 of a user U1 is equipped with a respective application CLT (or more simply client CLT). The client CLT is an example of that which generally may be defined a use information acquisition instrument adapted therefore to acquire information related to the first plurality of distinctive attributes AU of each user and to the second plurality of distinctive attributes AA of each good, and an additional use information IU representative of the occurred use of a good by a user. It is noted that the report of the occurred use may occur, as will be described below, both automatically (transparent to the user) and manually (directly carried out by the user).

To be issued the client CLT, the user connects to the Internet site of the management centre 100 or to the site of a commercially associated company (partner) with the management centre (100) and downloads an installation program of the client CLT free of charge. Alternatively, the user may use a multimedia support containing the installation program of the client CLT. Following this operation, the user provides the management centre 100 with its permission pertaining to conventional software license agreements and aspects tied to the privacy of the user himself. The client CLT comprises a software module which now may be installed on the local computer UT1 of the user U1.

From the software standpoint, the client CLT is an application for the Windows operating system whose main function is the playing of multimedia support (audio and video CDs and DVDs). The formats partially or totally supported by the present technology comprise, among others, Media and Video Files extension formats “.avi”, “.qt”, “.mov”, “.mpg”, “.mpeg”, “cmiv”, “.wmp” . . . . Audio File “.wav”, “.mpa”, “.mp2”, “.mp3”, “.au”, “.aif”; Midi Files “.mid”, “.midi”, “.rmi”. At the time of its execution, the client CLT is realised on the monitor MTR as a graphical or console interface, entirely analogous to the console applications usually dedicated for the playing of audio or video files, for example WinAmp and Windows Media Player. The client CLT is moreover employed by the user U1 for its registration at the management centre 100. This occurs by directly providing to the client CLT the respective personal data which is automatically sent to one of the computer servers associated with the management centre, for example the first computer server SRV1. The registration is necessary for the first use of the client. For the registration, the user U1 is required to compile the fields which are displayed on the client console. In particular, the required fields comprise fields related to the personal data of the user, including:

name (obligatory), text string with a defined maximum length;

last name (obligatory), text string with a defined maximum length;

sex (obligatory), chosen by means of the Male/Female button

date of birth (obligatory), composed of three selection fields (Select);

day (number from 1 to 31), the insertion of a number which is not consistent with the name of the month or year (leap year) will show an error with correction requested;

month (with visualisation of the month name), the insertion of a month name which is not consistent with the day or year (leap year) will show an error with correction requested;

year (number, from 1900 to the current year);

place of birth (obligatory), text string with a defined maximum length;

province of birth (obligatory), province can be selected from a predefined list;

fields related to the residence address, including:

street (obligatory), text string with a defined maximum length;

number (obligatory), text string with a defined maximum length;

postal code CAP (obligatory), text string with 5 characters which may only contain numbers;

municipality (obligatory), text string with a defined maximum length;

province (obligatory), province can be selected from a predefined list;

state (obligatory);

fields related to the contacts of the user, including:

fixed telephone number (initially optional and subsequently obligatory when for example a user asks for the activation of a service which necessarily requires such information), text string with a defined maximum length, may contain only numbers without spaces;

mobile telephone number (initially optional and subsequently obligatory when for example a user asks for the activation of a service which necessarily requires such information), text string with a defined maximum length, may contain only numbers without spaces;

fax number (optional), text string with a defined maximum length, may contain only numbers without spaces;

email address (obligatory), text string with a defined maximum length;

email address confirmation (obligatory), must be identical with the preceding field.

Moreover, for example, the user U1 is required to compile additional fields wherein he inserts the necessary information for an authentication procedure (login):

username (obligatory), text string with a defined minimum and maximum length; a uniqueness verification is carried out on the username, with possible advice given for similar and alternative usernames in case the one typed during registration had already been adopted;

password (obligatory), text string with a defined minimum and maximum length, it appears in an INPUT field of PASSWORD type (not visible);

Password confirmation (obligatory), must be identical to the preceding field, it appears in the INPUT field of PASSWORD type (not visible).

The compilation of several fields is initially optional and subsequently become obligatory if on using a service that necessarily requires it, the client advises the user to insert the data. The user will moreover have the possibility to modify his user profile in any moment.

Upon registration at the management centre 100, the user U1 will receive at the indicated postal address (for example the home address) a welcome letter accompanied by an activation CD for proving the veracity of the personal data registered in the installation step. The activation CD contains a control code (similar to an installation key) which enables the client to continue operating. If the activation CD insertion does not occur within a certain time period, for example one month from the registration, or in any case within the required time period, the client will be partially deactivated and only some modes will function without attributing points. Alternatively, the control code present in the activation CD may be substituted with an alphanumeric code which will be sent directly by means of paper mail (thus having the confirmation of the correctness of the address). The control code may be inserted only once and remains permanently associated with the profile of the user, and it may not be modified. If the user U1 has the need to install a new Client on another computer, it will be able to import his updated profile on the new computer (complete with alphanumeric code) without having to type it again. It should be noted that the control code is only typed at the first authentication (login) or at subsequent authentications within a predetermined time period.

With reference to the operation in general, it is noted that advantageously the client CLT automatically starts up with every startup of the local computer UT1. This functionality may in any case be eliminated by the user U1 and in the case wherein the audio and video player console preferred by the user U1 is different from the client CLT, the possibility to set the client CLT as predefined player is proposed to the user U1. In the case wherein this does not occur, the client CLT is advantageously capable of acquiring the first plurality of distinctive attributes AU of each user, the second plurality of distinctive attributes AA of each good and the use information IU related to the occurred use, even when a different player instrument is used.

In the example just described, the acquisition of the use information IU occurs automatically and in an entirely transparent manner for the user.

Moreover, it is observer that the client, at its startup, verifies that the user is correctly authenticated and if the user had previously set the automatic login, the client automatically carries out the login of the set profile. Otherwise the client sends the user U1 a message which asks him to carry out such operation manually, and as soon as the user chooses to authenticate himself the client sends him a login mask. Moreover, several user profiles may be present on a same computer, to such end the username field is a descending list which shows the list of profiles installed on the computer, permitting however the specification of a username which is not present on the list. It is also possible to create a new profile/identify. The first login is always manual, while the second login onward is automatic if the user has specified as such and if on the same computer other user profiles are not present.

Regarding the profiling method according to the invention, the case is now considered wherein the user U1 inserts in the reader LTR a first musical CD, from this point on simply indicated with CD1. The client CLT automatically executes the login of the user or requires the same to manually insert the username and password. It is known that the username and password employed are compared with the username and password stored at the local level in the memory MF of the computer UT1 at the time of the first authentication. If a correspondence is verified between the compared data, the user is successfully authenticated and the CD1 begins playing. This comparison advantageously occurs at the local computer level, relieving the first SRV1 and the second SRV2 computer server of the task of verifying the user authenticity. Moreover, in this manner, it is possible for a user to be authenticated and to play CDs even if the local computer is not connected to the Internet. In this case, the acquisition of the information can still occur at the local level, while the transfer of the same information to the management centre 100 takes place, as will also be confirmed below, at the time of the network connection.

Following the use of CD1, i.e. the playing or listening, the client CLT acquires information pertaining to the publishing data of CD1 (for example, the names of the composer and performer, title of the work, titles of the tracks, record company), associating them with information related to the authentication (username and password) of the user U1 and to the additional use information representative of the fact that the CD1 was used by the user U1. The authentication data of the user associated with the user data described above (personal data and address) constitute an example of plurality of attributes AU while the publishing data are an example of second plurality of distinctive attributes AA of the good, in this case CD1.

It is known that for the acquisition of the publishing data of a CD the playing of the same for its entire duration is not necessary; rather, only a few seconds of listening are sufficient. The association of the aforesaid information is made possible by the permission of the user U1 for the treatment of his personal data, which is requested several times, also in this step, by the management centre (usually in two or three steps on the console). The latter stores the information thus associated (AU, AA and IU) in a local database DBL in the memory MF of the local computer UT1 as well as in a main databases DBP in the memory of the first computer server SRV1. The stored information demonstrates that the user U1 has used CD1, and assuming that a user usually listens to a CD which he enjoys, this provides a first indication of the user profile U1 that the management centre prepares to build (for example, favorite musical type, artist, song title). At the same time as the CD1 playing, the management centre 100 assigns the user U1 one point to accrue in the point collection.

Each time the user U1 inserts a musical CD inside the reader LTR and plays it with the client CLT, the latter executes a recognition procedure to verify if the musical CD has already been registered inside the management centre 100 and then foresees possible updates of the databases (DBL and DBP).

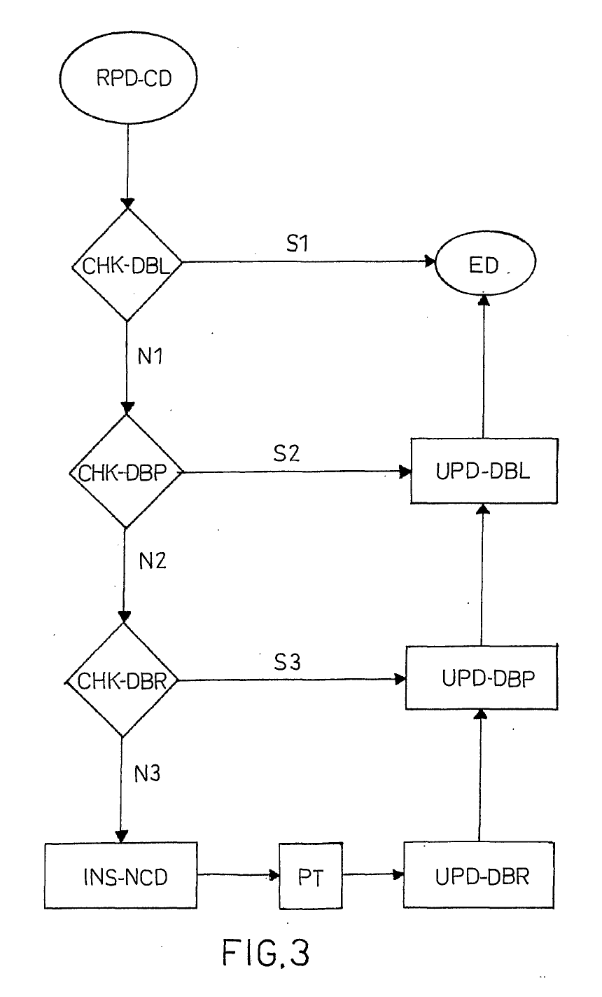

With reference to the block diagram of FIG. 3, the preceding case is always considered wherein the user U1 inserts the first musical CD CD1 in the reader LTR and plays it with the client CLT (RPD-CD step). The client acquires the publishing data of CD1 and associates it with the information of the user U1 as previously described. At this point, the client CLT checks if CD1 has already been used by the user U1, and therefore registered, seeing if the information just acquired is already present inside the local databases DBL (CHK-DBL step). The presence of the local database DBL advantageously permits always carrying out the first control at the local level, avoiding having to access the first or second computer server. Thus, the hardware performances on which the profiling method according to the invention is implemented are per se increased. If a first control gives a positive result (S1) for the user U1, no point is attributed since the CD1 has already been heard and the control operations terminate (ED) step. If the control is negative (N1), the client CLT continues, and compares the information acquired with the information contained in the main database DBP of the management centre 100 (CHK-DBP), for example present in the first computer server SRV1. If this second control is positive (S2), only 1 point is assigned to the user U1, and at the same time the local database DBL is updated (UPD-DBL step) and the control operations terminate (ED step). If the second control is negative (N2), the clients also consults a remote database DBR stored in one of the remote computers DB1-DBM (CHK-DBR step). If this third control is positive (S3), only 1 point is assigned to the user U1, and at the same time both the main database (UPD-DBP step) and the local database DBL (UPD-DBL step) are updated and the control terminates (ED). If the third control is negative (N3), the management centre 100, by means of the client CLT, requires the user U1 to insert (INS-CD step) the data of CD1 which after the controls did not result registered in any database. For this operation, the management centre 100 assigns the user two points (PT step). Following this operation, before the end of the control operations (ED), the remote database DBR (UPD-DBR step) may be updated at the same time with the new information, and the main database (UPD-DBP step) and local database DBL (UPD-DBL step) are also updated. It is known that if the management centre does not assign any point to the user U1, it in any case still updates the local database DBL and the database DBP with the information representative of the occurred use of the same CD (in this case CD1) by the user U1. This information in fact can once again be used at the management centre 100 to build the profile of the user U1. In summary, the recognition procedure, in relation to the described example, assigns:

one point for each CD which has never been inserted by a user but which is recognised by the management centre 100 (present in one of the databases);

two points for every CD which has never been inserted by a user and is not recognised by the management centre 100 (not present in the databases), if the user inserts the new information;

zero points for every CD which has never been inserted by a user and is not recognised by the management centre 100, if the user does not insert the new information;

zero points for each CD which has already been inserted by a user.

As already described, the points which can be attributed to the management centre 100 are in a different quantity according to the type of activity carried out by the user U1. There is a maximum number of points which can be accumulated in a predetermined time period, after which the management centre awards the user a prize (such as, for example, a giveaway) for his enjoyment (for example, twenty points in one month). Such points can also vary with special custom operations for specific companies and/or products. In the described example, achieved with the maximum ceiling of ten points, the user has the right to a prize which in the future the management centre 100 will choose from among those most relevant to the user U1 profile. For example, if the user U1 listens to classical music, he will be awarded a classical music CD, magazine, a ticket (or discount for the purchase of the same) for a musical event (for example a concert) or pertaining product/service. The prize can be sent to the address indicated by the user, or alternatively can be made available at a point of sale which can be selected by means of accessing a reserved area of the management centre 100. The management centre initially places a maximum limit of two prizes which the user U1 may receive in the span of one month. Nevertheless, such limit can vary as a function of the marketing policies adopted from time to time. It may also occur that in some periods or for specific prizes the user may be asked for a small contribution, for the logistical management of the product/giveaway. According to a preferred mode, such payment can be carried out by means of the main payment systems existing today (for example, credit card, Paypal, Postepay), appropriately integrated at the server and accessible directly by the Client or also by means of issued prepaid cards which have value on one or more circuits.

According to a further delivery mode of the prize, at least the first computer server SRV1 of the management centre 100 is connected with an ATM terminal network (Automated Teller Machine).

When a user U1 carries out a bank operation (such as a withdrawal) at an ATM terminal, the first server SRV1 can recognise the user U1 as one of the users profiled by the management centre 100. Following the recognition, the first server SRV1, having localised the employed ATM terminal, is capable of sending the user a message in real time by means of the terminal itself. For example, the contents of this message can be of custom advertising type (pertaining to his commercial profile) on the ATM terminal screen, and/or the printing of a voucher which permits the user himself to obtain, within a predetermined time period, a discount on the purchase of a good at an indicated store and very close to the same ATM terminal.

Regarding the possibility of making available the points collection without disrupting the accuracy standards in the generation of the user profile, it is known that the management centre 100 foresees the possibility for one same user to install the client CLT on different computers, for example a local computer UT2 at the office and a local computer UT3 at the house, authenticating with the same authentication profile. In this case, the points collected using musical CDs with the computer UT2 and those collected using CDs with the computer UT3 will be accumulated in single collection point. Moreover, the profiling method according to the invention permits the user to be able to employ the client CLT for making use of and receiving points related to all the musical CDs in his possession, independent of whether they are his property, whether they were lent, rented or even copied from an original CD (so-called burned single copy, permitted by the law on author's rights). It is moreover observed that the user can advantageously make use of optical support, commercialized and purchased before the date of registration of the user U1 at the management centre and installation of the client CLT on his computer, for example months or even years before. For this reason, the profiling method may be defined retroactive, or rather capable of reconstructing the user profile also based on optical support purchased before the actually date wherein the user U1 began using the service of the management centre 100.

Regarding for example different types of multimedia supports, the user U1 may make use of DVDs, and in this case the client CLT is capable of recovering the conventional publishing data of the DVD, adding to the user U1 profile information related, for example, to the favorite movie type (for example comedy) or favorite actor, and much more. Moreover, the user can be profiled by the management centre 100 based on the CD-ROM inserted in the reader LTR. It follows that if the CD-ROM is related to a PC game, the client adds to the user U1 profile further information related for example to the type of game (for example, role-playing or strategy game). Other examples of multimedia which can be used by the user are moreover the optical support dedicated and coded for the standard XBOX, Playstation1 and Playstation2.

According to another example, physical optical support are not employed, such as those described above, but the user may make use of multimedia files, for example audio files of “.mp3” type, stored in the memory of the local computer or accessible by means of the Internet network (on-line).

It is known that for the assignment of the points, in the case wherein DVDs or CD-ROMs are used, the recognition procedure is always carried out which is adapted to verify if the DVD or CD-ROM has been registered. To such end, the control is repeated several times on the different databases (DBL, DBP, DBR) according to the scheme already described with reference to FIG. 3.

Regarding the plurality of distinctive attributes AA of each good, the publishing data of a musical CD (or a DVD or CD-ROM) can optionally contain information related to the fact that that multimedia support was distributed on the market with a specialised magazine (for example, PC and computer specialised magazines very often have a CD-ROM attached, gratis or at a promotional price, with games and application programs for PCs). The profiling method in this case is capable of interpreting this additional information, adding to the user profile further information regarding the magazine. It is in fact foreseeable that among the prizes foreseen by the points collection there may also be the reception of free copies of the “favorite” magazine. In each case, it will be possible to trace the preferences of a user also with regard to his favorite reading.

Regarding the activities which the user can carry out by means of the client CLT, it is known that it proposes, among others, a conventional messenger service, the possibility to activate searches for key words and query criteria on the Internet by means of known search engines and the possibility to listen to on-line radio.

For example, the management centre 100 recognises that the user U1 is employing the client CLT, also possibly in messenger mode, and sends the user, by means of pop-up windows on the PC desktop, advertising messages (also in on-line continuous reading mode, so-called streaming), surveys. It should be noted that such messages are in any case always dedicated to subjects which the management centre creates specifically for the user U1, beginning with the known profile, or in any case for providing him with additional information. This aspect is very advantageous, since usually on-line or by email the messages are generic and usually are ignored by the users. In the case of the invention, the user U1 may see delivered to him, also via messenger, news which is of interest (so-called profiled advertising message). One important example can be the brief trailer related to the latest film of the favorite actor or the advertising message can communicate that tickets are available for the next concert of the favorite singer of the user U1 at a predetermined advance sales agency for musical events, as revealed through the audio-video CDs and DVDs or musical files which were previously used or listened to.

Regarding the surveys, these are generally brief questionnaires (maximum three or four questions) which the management centre 100 asks the user with regard to subjects of interest (in other words, profiled surveys). Moreover, while the messages do not assign points to the user U1, the surveys proposed attribute one or more points for each response.

Regarding the mode of the client CLT as search engine, the user U1 has the possibility to display on the console a menu comprising several of the more well-known international search engines, one of which may be chosen for use. The search service requires the insertion, by the user, of key search words and query criteria. The management centre 100 assigns one point to the user U1 each time he carries out a search, and subsequently acquires data related to the object of the search, updating the user profile. If the user carries out the research by employing the same key words and the same search engine, no additional point is assigned. On the other hand, the management centre assigns a point of the same search is carried out on a search engine which is different from the previous one. The searches can also be reserved off-line and can be subsequently displayed in a proprietary browser, in which they will be displayed with a multitab structure, one tab for each of the conducted searches.

Another activity which can be carried out by the management centre 100, by means of the client CLT, is the acquisition of additional profiled data of the user from the so-called list of “favorite” sites. Such list may be constructed by the user inside the client CLT, employable in browse mode. The assigning of the points occurs by monthly survey. Five points are assigned at the first survey (at the moment of the client installation) and one point for each modification or addition to the registered list at each survey.

An additional activity which can be carried out by the management centre 100, by means of the client CLT, is the acquisition of additional profiled data of the user when the latter is using the same client CLT to listen to on-line radio through the Internet.

Other activities capable of permitting the user to accumulate points by means of the use of the client CLT are, for example, the participation of the promotions declared by the management centre 100 and the indication of the service offered (client CLT and points collection) by the management centre to another user. In particular, for the first activity, purchasing a promotional good sold by the aforesaid client companies of the management centre 100 and manually inserting an univocal code present on the good's package in an appropriate field of the client CLT, the management centre verifies that the inserted code actually corresponds to a specific promotion, that it has not been previously used by the same user or by other users, and if there is a positive verification it assigns a score to the user. In this case, the indication of the occurred use of the good (for example, participating in the promotion) occurs manually by the user. For the second activity, the user has the possibility to specify the email address of another user in a field of the client CLT marked by the message “point out CLT to a friend”. The management centre 100 verifies the email address and if it recognises it as entirely new it assigns the user one point.

It is moreover noted that the management centre 100, in accordance with an editor announcing a prize competition, may preferably personalize only a part of a very wide circulation of multimedia supports distributed by said editor, each equipped with a code adapted to permit the user who makes use of one of said multimedia supports by means of the client CLT to win one of the prizes at stake in the prize competition.

A further activity which the user can carry out with the client CLT is to listen to on-line radio stations. In this case, the management centre 100 assigns three points to the first listening of a new radio station and one point for every first daily listening of the same radio station.

Moreover, a further activity which can be carried out by the management centre 100, by means of the client CLT, comprises periodic surveys of the equipping hardware components, for example the local computer UT1 associated with the user U1, on which the client CLT is installed, and the possible peripheral devices operatively associated with said computer. In particular, in this survey activity, the management centre 100 assigns the user U1 one point each time the hardware and possible peripheral devices are wholly detected in the predetermined time period, for example one month.

An additional activity which the user U1 can carry out by means of the client CLT is the possibility to provide the management centre 100 with further information regarding his profile pertaining to an identification code of an editorial publication LBR which the user may use, for example the so-called International Standard Book Number, ISBN of a novel LBR, more simply known as ISBN code. As is known, the ISBN coding system, currently used by 71 countries throughout the world and by UNESCO and managed by single agencies in every national, language or geographical area with the supervision of the International ISBN Agency, permits the universal coding of the editorial publications (books and novels) for their automatised management, immediately and with certainty identifying any title of the editors which use it. The ISBN code can be connected with the bar code EAN (European Article Numbering) with further considerable advantages in terms of ascertained identification of the book associated with the user.

The user U1 can manually insert the code ISBN in an appropriate field of the client CLT, usually printed on the cover of the novel in association with the respective bar code and the management centre 100, interfacing with specific external databases, recognises the title and publishing details of the identified novel, verifying that it has not been previously used by the same user, and, in the positive case, it assigns the user a score (for example one point), enriching the user U1 profile with additional information. The control of the possible already occurred use of the novel LBR, for assigning a respective score by the management centre 100, is carried out by the client CLT in a manner entirely analogous to the case wherein the user U1 makes use of an audio CD, as described in detail above with reference to FIG. 3. It is observed that the profiling method according to the invention permits the user U1 to be able to make use of and receive points related to all editorial publications in his possession, independent of whether they are his property or they were lent to him, for example by a library or friend. Moreover, as already described in the case of use of multimedia supports, the user can advantageously make use of editorial publications, commercialized and purchased before the date wherein the user U1 was registered at the management centre 100 and installed the client CLT on his computer. Also for this type of goods, the profiling method may be defined retroactive, or rather capable of reconstructing the user profile also based on publications purchased before the actual date wherein the user U1 began using the service of the management centre 100, for example months or even years before.

It is observer that, also in the case of the additional activity just described related to the profiling of a user by means of the acquisition of additional information related to a novel in the user's possession, the insertion of the information related to the ISBN code of the novel LBR occurs manually by the user.

Considering the activities described up to now, it is observed that for the updating of the databases (DBL, DBP, DBR) and the control of the already occurred use or survey, the local computer of the user must be connected to the Internet (on-line mode). It is noted, however, that for the acquisition of the profiling information the on-line mode is not always necessary. There are in fact several functioning modes of the client CLT wherein the local computer UT1 can be temporarily disconnected from the Internet (off-line mode). In this case, the client is considered operating in “rest” mode, i.e. capable of working off-line and storing the information acquired in a data packet, recognising at the moment wherein the user activates the Internet connection, the “connected” mode, so to update and adjust both the databases and the point collection. When the local computer is off-line, the client is a conventional CD player. At the moment of its use, the user is however requested for authorisation on the local level. It should be recalled that, as said above, the login data are stored in the local computer because they allow the use of the client even in “rest” mode. If the login information was stored only at the level of the first SRV1 or second SRV2 computer server, the Internet connection would inevitably be required at the time of the login. Once the login has been carried out, if in “rest” mode, the client CLT is capable of acquiring information related, for example, to the number of times and the date in which a CD is used by the user even when the computer is “not connected”. On other hand, there are several modes wherein the Internet connection of the user's computer is necessary. This is the case, for example, of the CLT mode as search engine, at least limited to the use in real time, messenger (profiled advertising messages and surveys) and for the acquisition of information from “favourite” sites.

Regarding once again the points collection, the user may decide in any moment to suspend his registration at the management centre 100. This is not a cancellation at the physical level but only at the logical level. This deactivation implies that the management centre 100 will no longer send the user information and consequently the user will no longer participate in the assignment of a score. The management centre 100 will however continue to acquire information from the user and goods used. In the case wherein the user does not wish the management centre to acquire these data, the user must uninstall the client from his local computer.

Regarding the main database DBP, this comprises concatenated tables which include the first plurality of distinctive attributes AU of each user, the second plurality of distinctive attributes AA of each good and the respective use information IT representative of the fact that the user has used the good. These concatenated tables are made available by the management centre 100, for example with a sales agreement, to firms or companies (in general clients) associated with the plurality of client computers CL1-CLP. In particular, the management centre 100 provides the clients CL1-CLP with a reserved portal which can be consulted via Internet. To access said portal, authentication is necessary by means of client identification (client username) and a client key word (client password) provided by the management centre 100. Regarding the information of which the client may gain, it is known that the reserved portal foresees at least two different modes with which the client may collect data. A first mode foresees the presence of previously compiled questions for creating an established user profile (for example responses to several of said questions may be: “musical genre: classical music”; “Users between 20 and 30 years old”; “Residents of Northern Italy”; “Male Sex”). A second mode instead permits the client himself to build an interest profile ad hoc, compiling search fields with user attributes and good attributes, following the instructions of a dedicated application program (wizard).

It is possible to extract from the main database DBP a report of so-called associated data, inside of which it is possible to carry out additional queries both along a drill-up index and along a drill-down index. In particular, the aforesaid report can be visualised both in table form and in graphical form and can be exported and laid out inside an electronic spreadsheet such as Excel or in a document of Word type. It is observed that the associated data does not contain the personal data of the users, which for obvious reasons of privacy and company policy are not divulged.

Moreover, one of the CLP clients can study the associated data report, identifying and selecting a target of users to which it wishes to send a respective promotional message. The CLP clients, not knowing the addresses of the users belonging to the chosen target, entrust the sending of said promotional messages directly to the management centre 100. The sending may occur by paper mail or on any electronic or computer means (for example fax, SMS, email, client and telephone).

It is known that the client may identify the promotional message type to be sent to each client on the basis of appropriate reachability information which identifies the particular forwarding type of the message.

The profiling method according to the invention permits building the user profile even on the basis of goods which date before the installation of the client CLT and the registration at the management centre 100. This mode of acquiring the so-called retroactive data permits the user to quickly collect points and at the same time rapidly and dynamically update the main database DBP of the management centre 100. Moreover, the fact that the client application is available for free and that the points collection is per se easy and uncomplicated for the user and linked to many uses of services through the Internet permits the user himself to receive so-called profiled prizes, a strong incentive for the consistent and regular use of the offered service.

Moreover, it should also be considered that, in an entirely innovative manner, the recognition of the prizes/giveaways occurs when the user has reached a ceiling of points corresponding with a related prize and moreover no type of prize drawing occurs as in normal prize competitions.

All this represents a user loyalty system which is entirely innovative, for which commonly used hardware and software are required. To such end, the fact that the participation in the points collection does not require the user to make any kind of purchase advantageously represents a further incentive for the use of the described loyalty system.

Additionally, the acquired profiled data are available to the clients of the management centre 100 and represent a dynamic database, continuously updated and containing information related to goods and products which are dated but still useful for the market research requested by the companies which operate in the entertainment, advertisement or marketing sectors.

1. Profiling method of a plurality of users (UT1-UTN) of goods comprising:
prearranging, in a main database (DBP) associated with a management centre (100), a first plurality of distinctive attributes (AU) of each user and a second plurality of distinctive attributes (AA) of each good;
providing each user with a respective use information acquisition instrument (CLT);
acquiring, by means of said instrument (CLT) and during a use of goods by the users, respective use information (IU) representative of the occurred use;
storing, in the database (DBP), said respective use information (IU), associating it with the corresponding user and the corresponding good.

2. Profiling method according to claim 1, wherein the use of the good occurs by means of interaction of the good with an electronic device (LTR) associated with each user.

3. Profiling method according to claim 2, wherein said acquisition instrument (CLT) comprises a software module installable on an electronic computer (UT1) operatively associated with said electronic device (LTR).

4. Profiling method according to claim 1, moreover comprising:
examining the database for collecting associated profiling data representative of the behaviour of the users and including the use information and at least a portion of the first and second plurality of attributes.

5. Profiling method according to claim 4, moreover comprising:
selling the associated data to at least one entity (CL1) separate from the management centre (100) and the plurality of users (UT1-UTN), said associated data comprising information representative of the reachability of the respective users.

6. Profiling method according to claim 5, moreover comprising:
providing incentives for the plurality of users (UT1-UTN) to use the data acquisition instrument (CLT).

7. Profiling method according to claim 6, wherein providing incentives comprises assigning at least one prize to the users who make use of the goods by means of the acquisition instrument.

8. Profiling method according to claim 7, wherein assigning at least one prize comprises assigning at least one score to the users based on the use of a new good, said at least one prize being assigned upon attaining a predetermined value of said score.

9. Profiling method according to claim 2, wherein the good is a multimedia support and the interaction of the good with the electronic device comprises playing (RPD-CD) the multimedia support.

10. Profiling method according to claim 9, wherein the second plurality of distinctive attributes of the good comprises publishing data of the multimedia support.

11. Profiling method according to claim 9, wherein said multimedia support is provided to users as an attachment to a magazine.

12. Profiling method according to claim 9, wherein the multimedia support is included among the group comprising: audio CDs, audio and video DVDs, data CD-ROMs, XBOX optical support, Playstation1 optical support, Playstation2 optical support.

13. Profiling method according to claim 2, wherein the good is a multimedia file stored on the electronic computer (UT 1).

14. Profiling method according to claim 2, wherein the good is a multimedia file accessible from the Internet.

15. Profiling method according to claim 3, wherein said software module comprises a console-interface of multimedia supports playing.

16. Profiling method according to claim 1, wherein the acquisition instrument comprises at least one search engine and the good comprises a search service, said search service requiring the insertion of key words and query criteria.

17. Profiling method according to claim 16, wherein said second plurality of attributes includes said key inquiry words.

18. Profiling method according to claim 3, wherein said good comprises a messenger service for communication by means of an Internet network and the acquisition instrument comprises messages sent to the user by means of the messenger service from the management centre (100), including surveys related to additional goods which can be used by the user.

19. Profiling method according to claim 1, wherein the acquisition instrument is associated with a browser and the good is the list of the user's favorite sites.

20. Profiling method according to claim 3, wherein the storing in the main database (DBP) comprises sending the use information by means of an Internet connection from the electronic computer (UT1) to the management centre (100).

21. Profiling method according to claim 20, wherein the use of the good occurs in one of the following operative conditions: activated Internet connection or deactivated Internet connection.

22. Profiling method according to claim 1, wherein the use of goods occurs by means of a multimedia supports player which is different from the acquisition instrument.

23. Profiling method according to claims 1, moreover comprising the storing of the use information associated with the corresponding user and the corresponding good in a local database (DBL), said local database being associated with the electronic computer of the user.

24. Profiling method according to claim 10, wherein the second plurality of distinctive attributes of each good is moreover comprised in at least one remote database (DPR) dedicated to the cataloguing of multimedia supports.

25. Profiling method according to claim 23, moreover comprising controlling (CHK-DBL) if a good used by the user is registered (S1) in the local database (DBL).

26. Profiling method according to claim 1, comprising moreover controlling (CHK-DBP) if a good is registered in the main database (DBP) when it is verified that said good has not been registered (N1) in the local database (DBL).

27. Profiling method according to claim 23, comprising updating (UPD-DBL) the local database (DBL) with corresponding attributes of a good if the good is registered (S2) in the main database (DBP).

28. Profiling method according to claim 24, comprising moreover controlling (CHK-DBP) if a good is registered in the at least one remote database (DBR) when it is verified that said good has not been registered (N2) in the main database (DBP).

29. Profiling method according to claim 24, moreover comprising updating (UPD-DBP) the main database and updating (UPD-DBL) the local database with attributes of a good when the good is present (S3) in the at least one remote database (DBR).

30. Profiling method according to claim 24, moreover comprising a user's inserting (INS-NCD) in the at least one remote database (DBR) attributes of a new good which was not previously registered (N3) in the at least one remote database (DBR).

31. Profiling method according to claim 30, moreover comprising updating (UPD-DBP) the main database and updating (UPD-DBL) the local database with the attributes of the new good.

32. Profiling method according to claim 30, wherein inserting the new good (INS-CD) comprises assigning a score to the user.

33. Profiling method according to claim 3, wherein the electronic computer (UT1) moreover comprises a processing unit (UE) operatively associated with a monitor (MTR), a keyboard (TST), a mouse (MES) and an electronic device (LTR).

34. Profiling method according to claim 33, wherein the processing unit comprises a volatile memory (MV), a non-volatile memory (MF) and a microprocessor (UC).

35. Profiling method according to claim 33, wherein the electronic device is a reader of multimedia supports.

36. Profiling method according to claim 6, wherein providing incentives comprises providing said acquisition instrument (CLT) to the users for free.

37. Profiling method according to claim 8, wherein assigning at least one score comprises assigning a score to a first user who has indicated the name of a potential new user to the management centre (100).

38. Profiling method according to claim 1, wherein the good is an editorial publication (LBR) and the acquisition of said respective use information (IU) comprises the step of the user inserting an identification code of said editorial publication in a respective field of said acquisition instrument (CLT).

39. Profiling method according to claim 38, wherein said identification code is the International Standard Book Number, ISBN.

40. Profiling method according to claim 7, wherein assigning at least one prize moreover comprises assigning at least one score to the user based on a full periodic survey of hardware components of the electronic computer (UT1) associated with said user.

41. Profiling method according to claim 7, wherein the step of assigning at least one prize comprises sending a dedicated message from the management centre (100) towards an ATM terminal (Automatic Teller Machine) used by the user for bank operations.

42. Profiling method according to claim 41, wherein said dedicated message is at least one of the following messages: a custom advertising message on a screen of the ATM terminal, a paper message received upon printing a receipt voucher which permits the user himself to obtain, within a predetermined time period, a discount on the purchase of a good.

43. Profiling method according to claim 1, wherein the step of providing each user with a respective use information acquisition instrument comprises a step of registering the user at the management centre (100); the goods being placed on the market months or years before said registration step.

44. Telematic network for the profiling of a plurality of users of goods comprising:
a management centre (100) of user profiling data;
an electronic computer (UT1) associated with a user equipped with a respective use information acquisition instrument (CLT) such to acquire, during a use of a good by the user, a respective use information representative of the occurred use;
a main database (DPB) associated with the management centre (100) adapted to store the use information, associating it with the corresponding user and the corresponding good.

45. Telematic network according to claim 44, wherein the electronic computer (UT1) is operatively associated with an electronic device (LTR) for the use of the good and the acquisition instrument (CLT) comprises a software module which can be installed on the electronic computer (UT 1).

46. Telematic network according to claim 44, moreover comprising an entity (CL1), separate from the management centre (100) and from the plurality of users, adapted to examine the main database (DBP) and collect associated profiling data representative of the behaviour of the users, including use information and at least a portion of a first and second plurality of distinctive attributes of the user and the good, respectively, said associated data being provided by the management centre (100) to said separate entity based on a sales agreement.

47. Telematic network according to claim 44, wherein the good is realised in at least one of the following forms: multimedia support, CD, DVD, CD-ROM, XBOX optical support, Playstation1 optical support, Playstation2 optical support, search engine, messenger service, list of favorite sites, on-line radio, and hardware components of an electronic computer associated with the user, editorial publications.

48. Computer program loadable in a memory (MV, MF) of an electronic computer (UT1) associated with a user of goods, said program comprising codes capable of:
acquiring a first plurality of distinctive attributes of the user;
acquiring, during the use of a good by the user, a second plurality of distinctive attributes of the good;
acquiring, during said use of the good, use information representative of the occurred use;
generating associated information obtained by associating the use information to the first plurality of distinctive attributes of the user and to the second plurality of distinctive attributes of the good.

49. Computer program according to claim 48, moreover comprising codes capable of providing a main database (DBP) of the management centre (100) said associated information.

50. Computer program according to claim 48, wherein the codes are such to permit the acquisition of the first and second plurality of attributes and use information in the cases wherein said good has at least one of the following forms: multimedia support, CD, DVD, CD-ROM, search engine, messenger service, list of favourite sites, on-line radio, hardware components of an electronic computer associated with the user, editorial publications.

51. Computer program according to claim 49, comprising codes capable of providing said associated information to the main database (DBP) associated with the management centre (100) by means of a connection to the Internet.
